(19) United States
(12) Patent Application Publication
(10) Pub. No.: US 2015/0020760 A1
(43) Pub. Date: Jan. 22, 2015

(54) Four-cycle Internal Combustion Engine

(71) Applicant: ETG Limited, Hong Kong (CN)

(72) Inventors: Katsumi KURIHARA, Aichi (JP); Shigeo YAMAMOTO, Hiroshima (JP)

(21) Appl. No.: 14/510,171

(22) Filed: Oct. 9, 2014

Related U.S. Application Data
(63) Continuation-in-part of application No. 13/239,803, filed on Sep. 22, 2011.

(51) Int. Cl. F01L 1/047; F02B 63/02; F01M 9/10; F01L 1/18; F01M 9/06

(52) U.S. Cl. CPC F01L 1/047; F01L 1/18; F01M 9/06; F01M 9/106; F02B 63/02
USPC 123/90.31; 123/90.44

(57) ABSTRACT

A four-cycle engine has an engine block having a cylindrical bore and an enclosed oil reservoir. Lubrication oil is inhaled from the oil reservoir and splashed to lubricate inner parts of the engine. The engine is provided with a cylinder head assembly having a pair of overhead intake and exhaust valves. Reciprocating intermediate lifters are provided between push rod and cam flowers to actuate the valve train. A push rod chamber communicated with the valve chamber is partitioned from the cam chamber and flowing of excess oil from the cam chamber into the valve chamber is prevented. Length of valve train push is shortened and it makes design of high speed engine properly.

### CROSS REFERENCE TO RELATED APPLICATION

This is a continuation-in-part application of U.S. patent application Ser. No. 13/239,803 filed on Sep. 22, 2011, the entire contents of which are incorporated herein by reference.

### BACKGROUND OF THE INVENTION

1. Field of the Invention

This invention relates to an engine, for example, a four-cycle internal combustion engine which is particularly suitable for the use with portable or transportable power tools.

2. Description of the Related Art

U.S. Pat. No. 7,287,508 to Kurihara and U.S. Pat. No. 7,624,714 to Kurihara et al., which are incorporated herein by reference, disclose a light weight and compact small four-cycle engine construction.

Portable power tools such as line trimmers, blower/vacuums, chain saws are mostly powered by two-cycle internal combustion engines or electric motors. Some transportable power tools such as tiller/cultivators, generators are currently powered by two-cycle or four-cycle internal combustion engines. With the growing concern regarding air pollution, there is increasing pressure to reduce the emissions of both portable and transportable power equipment. Electric motors unfortunately have limited applications due to power availability for corded products, and battery life and power availability for cordless devices. In instances where weight is not an overriding factor such as lawn mowers, emissions can be dramatically reduced by utilizing heavier four-cycle engines. When it comes to power tools such as line trimmers, chain saws and blower/vacuums, four-cycle engines pose a difficult problem. Four-cycle engines tend to be too heavy for a given horsepower output and lubrication becomes a problem since portable or transportable power tools must be able to be operated in a wide range of orientations except generators or tiller/cultivators. For some tiller/cultivators powered by four-cycle engines with vertical power shafts, lubrication also becomes a problem since it is difficult to use the same lubrication system as engines with horizontal power shafts.

Therefore, it is an object of an embodiment of the present invention to provide a small four-cycle internal combustion engine having low emissions that is sufficiently light weight to be carried and/or transported by an operator. The engine according the embodiment of the present invention is suitable for, for example, a hand-held or transportable power tool.

It is a further object of an embodiment of the present invention to provide a small four-cycle internal combustion engine having an internal lubrication system that enables the engine to be operated at a wide variety of orientations typically encountered during normal operation.

It is a further object of an embodiment of the present invention to provide a small lightweight four-cycle engine having an engine block, an overhead valve train and a lubrication system to splash oil mist to lubricate the crankshaft chamber throughout the normal range of operating positions.

It is a further object of an embodiment of the present invention to provide a lubricant return system to return lubrication oil into an oil reservoir after lubricating parts in the crankshaft chamber and the overhead valve chamber.

In the above-described related art, circular and scroll-type walls play important roles. However, the construction of these walls is not so cost effective. Further, the configuration of the walls is not compact. Thus, it is a further object of an embodiment of the present invention to provide a cost effective and compact wall configuration.

These and other objects, features, and advantages of the present invention will become apparent upon further review of the remainder of the specification and the accompanying drawings.

### SUMMARY OF THE INVENTION

In order to achieve the above objects, a four-cycle, internal combustion engine is provided which is suitable for use with portable or transportable power tools. The four-cycle engine is provided with an engine block having at least one cylindrical bore oriented in a normally upright orientation having an enclosed combustion chamber.

A lower case is attached to the said cylinder block with a horizontal mating plane. The cylinder block and said lower case form a crankshaft chamber. A crankshaft is pivotally mounted within the crankshaft chamber. An enclosed oil reservoir is located below the crankshaft chamber separated from the crankshaft chamber by a substantially circular wall.

A pump is connected drivably to cam gear-cam assembly, and said pump inhales lubrication oil from the oil reservoir to splash oil into the cylinder.

When lubrication oil is properly filled, the engine is able to rotate or to be stored without oil flowing into combustion chamber at any inclination position.

### BRIEF DESCRIPTION OF THE DRAWINGS

FIG. 1 is a cross-sectional side elevation view of the engine taken along the rotating axis of the crankshaft and axis of cylinder bore taken along line I-I in FIG. 2.

FIG. 2 is a cross-sectional side elevation view of the engine taken along line II-II in FIG. 1;

FIG. 3 is an enlarged schematic illustration of the camshaft and the follower mechanism.

FIG. 4 is a cross-sectional side elevation view of the engine of FIG. 2 when it is oriented to be upside down.

FIG. 5 is a cross-sectional side elevation view of the engine of FIG. 1 when it is oriented to be upside down.

FIG. 6 is a section view of the oil pump cover that shows the detail construction of inlet and outlet cavities of the pump taken along line VI-VI in FIG. 11.

FIG. 7 is a section view of the cylinder block and the lower case taken along line III-III in FIG. 1.

FIG. 8 is an elevation view of the cylinder block viewing from A in FIG. 7.

FIG. 9 is a cross-sectional side elevation view of the engine of FIG. 1 when it is oriented with the power take off end down.

FIG. 10 is a cross-sectional side elevation view of the engine of FIG. 1 when it is oriented with the power take off end up.

FIG. 11 is an enlarged view of the pump shown in FIG. 1.

FIG. 12 is a cross-sectional side elevation view of the engine according to one of other embodiments of the present invention.

FIG. 13 is a cross-sectional side elevation view of the engine of FIG. 12 when it is oriented to be upside down.

FIG. 14 is a cross-sectional side elevation view of the engine according to another one of other embodiments of the present invention taken along the rotating axis of the crankshaft and axis of cylinder bore taken along line I-I in FIG. 15.

FIG. 15 is a cross-sectional side elevation view of the engine according to another one of other embodiments of the present invention taken along line II-II in FIG. 14.

FIG. 16 is an enlarged schematic illustration of the cam shaft and the cam follower and the intermediate lifter mechanism in the engine shown in FIG. 14 and FIG. 15.

### DESCRIPTION OF THE EMBODIMENTS

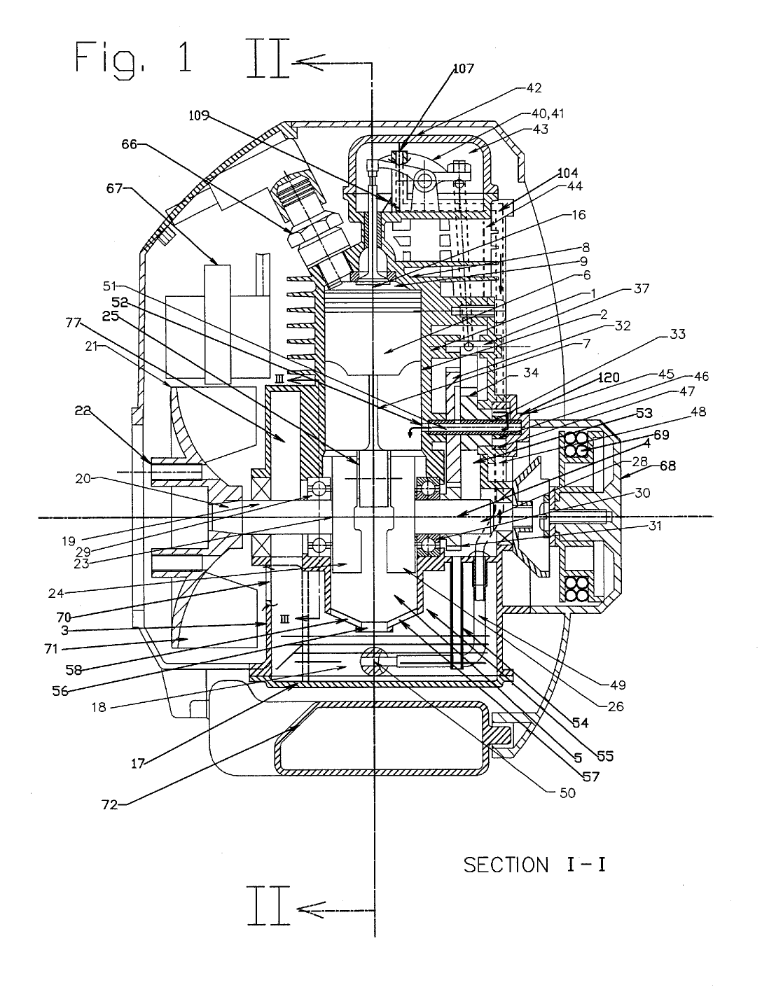

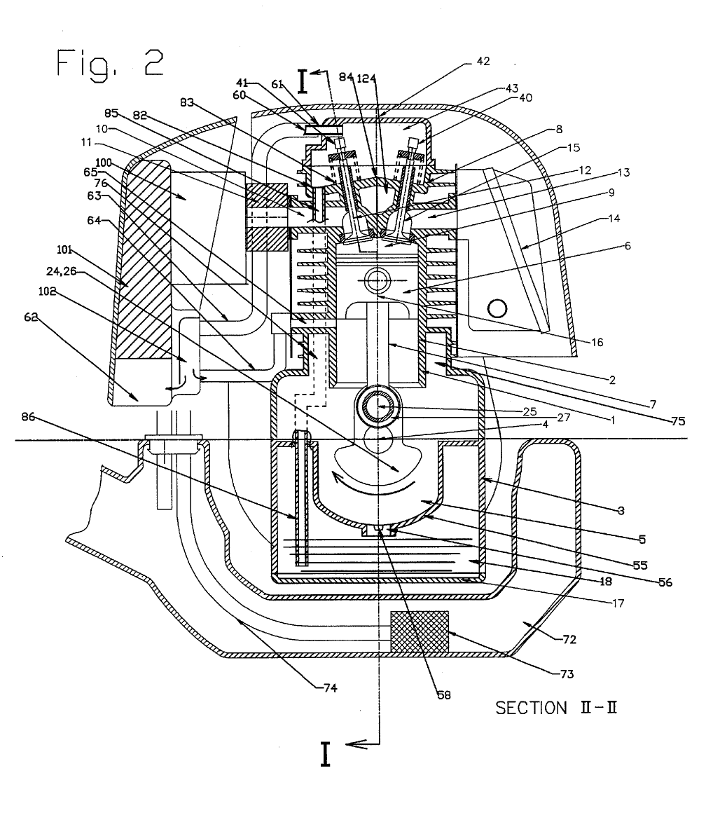

FIG. 1 and FIG. 2 illustrate a cross-sectional side elevation view of a four-cycle engine. The four-cycle engine is made up of a lightweight aluminum housing including a cylinder block 1 having a cylindrical bore 2 formed therein.

A lower case 3 and said cylinder block 1 mate with each other at the horizontal interface and form a crankshaft chamber 5.

A crankshaft 4 is pivotally mounted within the crankshaft chamber 5. The axis of said crankshaft 4 is contained at the horizontal interface to mate cylinder block 1 and lower case 3.

A piston 6 slides within the cylindrical bore 2 and is connected to the crankshaft 4 by a connecting rod 7. A cylinder head 8 is integrated to the engine block 1 to define an enclosed combustion chamber 9.

The cylinder head 8 is provided with an intake port 10 coupled to an insulator 11 and a carburetor 100 and selectively connected to the combustion chamber 9 by an intake valve 12. A filter element of air cleaner 101 eliminates dust from the intake air into the engine. The cylinder head 8 is also provided with an exhaust port 13 connected to a muffler 14 and selectively connected to the combustion chamber 9 by an exhaust valve 15.

As illustrated in FIGS. 1 and 2, the cylinder axis 16 of four-cycle engine is generally upright when in normal use.

The lower case 3 is connected to a bottom cover 17 that provides an enclosed oil reservoir 18.

The crankshaft 4 is provided with an axial shaft member 19 having an output end 20 adapted to be coupled to a flywheel 21 which has an implement input member 22. An input end 23 of axial shaft member 19 is coupled to a counterweight web 24. A crankpin 25 is affixed to counterweight webs 24, 26 and is parallel to and radially offset from the axial shaft 19. The crankpin 25 pivotally cooperates with a roller bearing 27 (FIG. 2) mounted in connecting rod 7.

The axial shafts 19 and 28 of crankshaft 4 are pivotally attached between the cylinder block 1 and the lower case 3 by a pair of bearings 29 and 30. At the side of bearing 30, a crank gear 31 is mounted on the crankshaft 4 in a cam chamber 53.

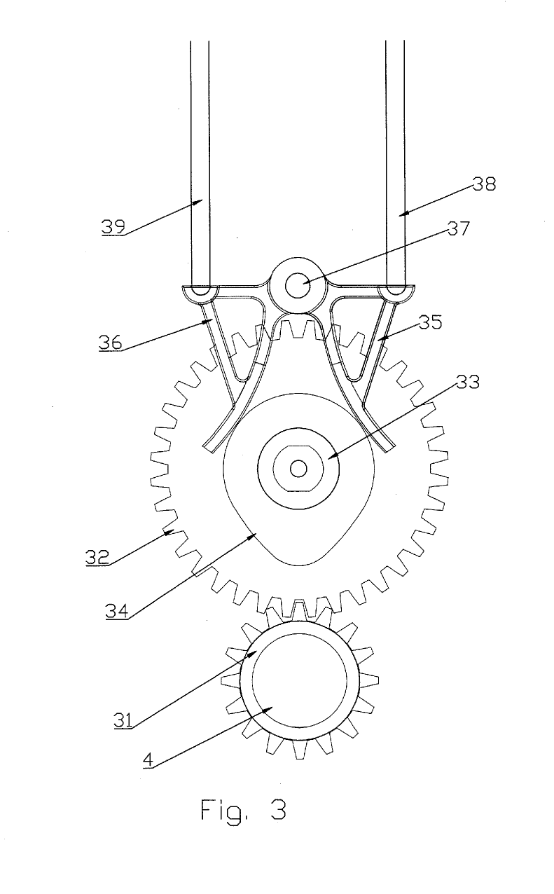

A camshaft drive and a valve lifter mechanism is best illustrated in FIGS. 1 and 3. The crank gear 31 mounted on the crankshaft 4 in turn drives a cam gear 32 with twice the number of teeth as the crank gear 31, resulting in the camshaft 33 rotating in one-half engine speed. The cam gear 32 is affixed to a camshaft 33 which is journaled to the cylinder block 1 and includes a rotary cam lobe 34. In the embodiment illustrated, a single cam lobe is utilized for driving both the intake and exhaust valves. Followers (cam followers) 35 and 36 are pivotally connected to the cylinder block 1 by a pivot pin 37.

Push rods 38 and 39 extend between camshaft followers 35 and 36 and rocker arms 40 and 41 located within the cylinder head 8. The cam 34, push rods 38, 39 and rocker arms 40, 41 are part of a valve train. More specifically, the valve train is constituted by components such as the cam 34, the followers 35, 36, the rocker arms 40, 41, the valves 12, 15, the valve spring 83, and a valve retainer. Affixed to the cylinder head 8 is a valve cover 42 which defines an enclosed valve chamber 43 therebetween.

A wall 44 surrounds the intake and exhaust push rods 38 and 39 in order to prevent the entry of dirt into the engine.

The cam chamber 53 and the valve chamber 43 are in communication with each other.

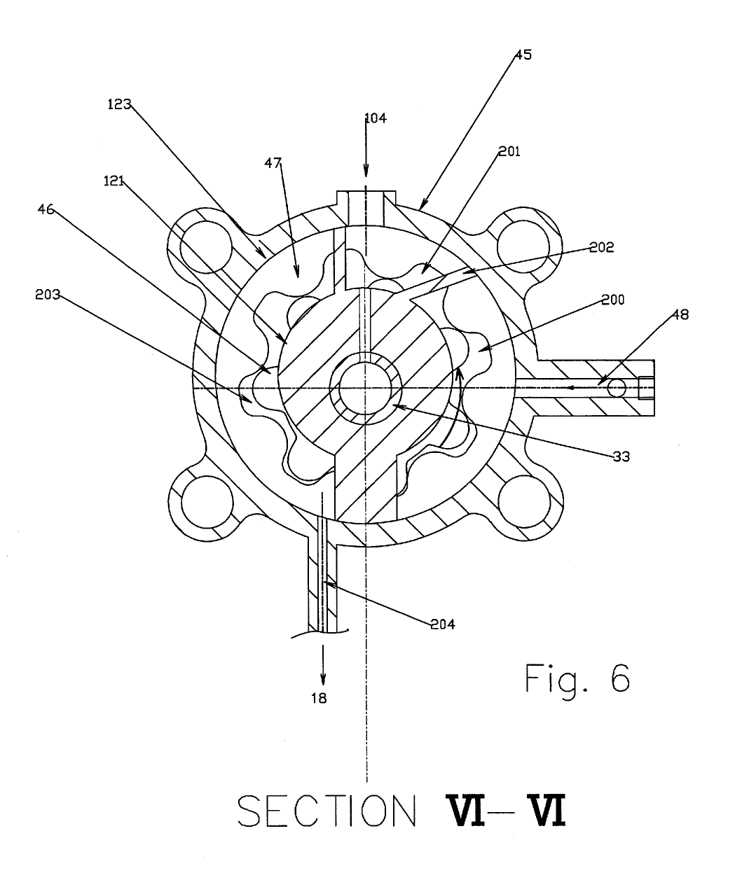

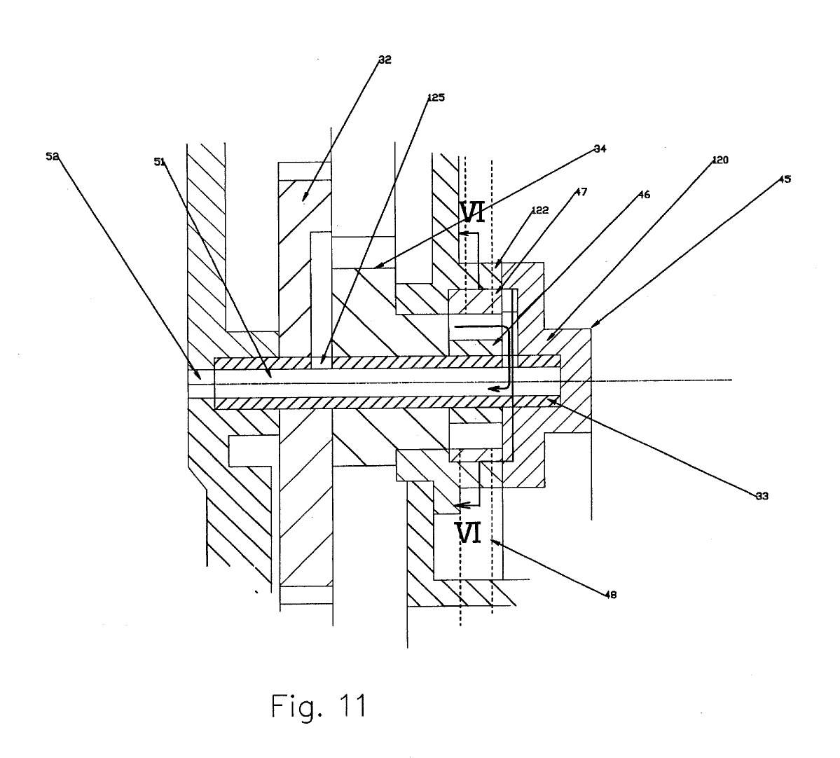

In order to lubricate the engine, a pump (oil pump) 45 such as a trochoid pump is placed at the side of cam gear 32. As illustrated in FIG. 1, FIG. 6 and FIG. 11, the pump 45 is formed of a stationary pump cover 120 including an inner portion 121 mounted on the camshaft 33 and a stationary pump body 122 including an annular outer portion 123 coaxially disposed around the inner portion 121 with a certain distance from the inner portion 121, an inner rotor 46 formed on the outer surface of the camshaft 33 and an outer rotor 47 formed on the inner surface of the outer portion of the pump body 122. In other embodiments of the present invention, a gear pump or a plunger pump may be alternatively used as the pump 45.

The inner rotor 46 formed on the outer surface of the camshaft 33 is driven by the cam gear 32, and the outer rotor 47 formed on the inner surface of the outer portion 123 is rotated following the rotation of the inner rotor 46. Lubrication oil is inhaled from the passage 48. One end of the passage 48 leads to an oil entrance of the pump 45. The other end of passage 48 is connected to one end of a flexible tube 49. The other end of flexible tube 49 is connected to a filter with weight 50. By means of the weight 50, an entrance of the flexible tube 49 is dipped in the oil in the oil reservoir 18 at any orientation of the engine.

The oil pushed out by the pump 45 is lead in parallel to a hole 52 formed in the cylinder wall and a hole 125 formed in the outer wall of the cam shaft 33 through an inner through hole 51 of the cam shaft as illustrated in FIGS. 1 and 2. Accordingly, the engine parts inside the crankshaft chamber 5 and the cam chamber 53 are mist lubricated by the oil splashed by means of the rotation of and/or the centrifugal force generated by the rotating parts such as web 24, 26.

As illustrated in FIGS. 1 and 2, a circular arc wall 55 surrounding the counterweight web 24,26 of the crankshaft 4 separates crankshaft chamber 5 from the oil reservoir 18. The arc wall 55 is substantially co-axial with the axis of the counterweight web 24 or 26 and is located with a certain distance from the webs 24 and 26.

At the bottom of circular arc wall 55, a drain hole 56 is provided. Slit 57 and 58 are provided at the bottom of circular arc wall 55 to communicate with the crankshaft chamber 5 and the oil reservoir 18.

At the side of the cylinder block 1, a drilled oil passage 104 is provided. One end of the passage 104 leads to the oil entrance of the pump 45 together with the passage 48. The other end of passage 104 leads to an upper portion in the valve chamber 43 as illustrated in FIG. 1.

A small hole 109 is opened from the valve chamber to the passage 104 near the bottom surface of the valve chamber.

In other embodiments of the present application, a flexible tube may be used to provide passage 104. An oil inlet 107 is provided at the other end of the passage 104.

As best illustrated in FIG. 6 and FIG. 11, the pump 45 has a first inlet cavity 200 which inhales oil from the oil reservoir 18 through the passage 48, and a second inlet cavity 201 which inhales oil from the valve chamber 43 through the passage 104.

Between the first inlet cavity 200 and the second inlet cavity 201, a wall 202 is provided to separate the cavities 200 and 201. An outlet cavity 203 provides a passage for oil to the cylinder bore through the inner hole 51. A relief oil passage is formed in the outer portion 123 of the pump body 122. One end of the relief oil passage 204 opens to the outlet cavity 203. The other end of the relief oil passage 204 opens to the oil reservoir 18 through a drilled hole (not shown).

In the valve chamber 43, a breather pipe 61 is opened through the valve cover 42. One end of the breather pipe 61 is connected to an air cleaner case 62 through a breather tube 63. At said one end of breather pipe 61, a check valve 60 is installed. The check valve 60 opens when the pressure in the valve chamber 43 is higher than the pressure in the breather tube 63, and the check valve 60 closes when the pressure in the valve chamber is lower than the pressure in the breather tube 63. In the air cleaner case 62, an oil separating deflector 102 is provided. The breathing oil mist provided through the breather tube 63 is separated into oil-lean gas and oil-rich gas by the deflector 102.

A return tube 64 interconnects the air cleaner case 62 and a return hole 65 formed in the cylinder wall. The return hole 65 opens and closes with a reciprocating motion of the piston 6 and the oil-rich mist returns into the crankshaft chamber 5 only when the pressure in the crankcase is negative. The oil-lean mist is inhaled to the carburetor 100 through the filter element 101.

As illustrated in FIG. 2, around the outside wall of cylinder bore in the crankshaft chamber 5, oil recess 75 and 76 are provided.

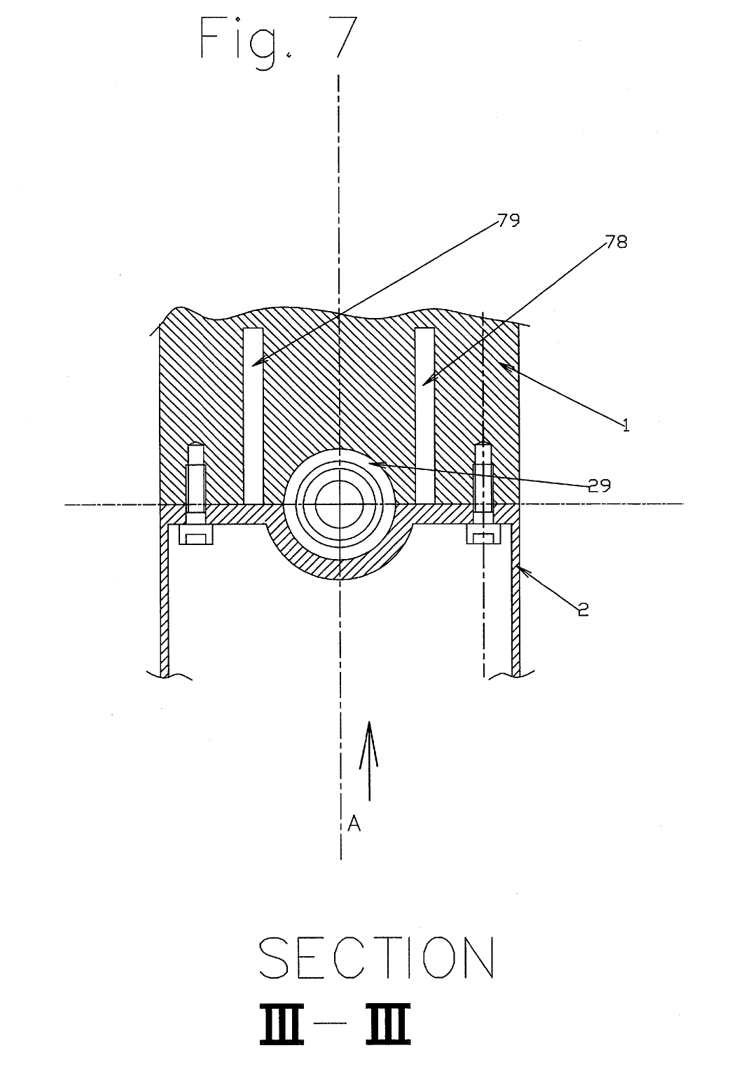

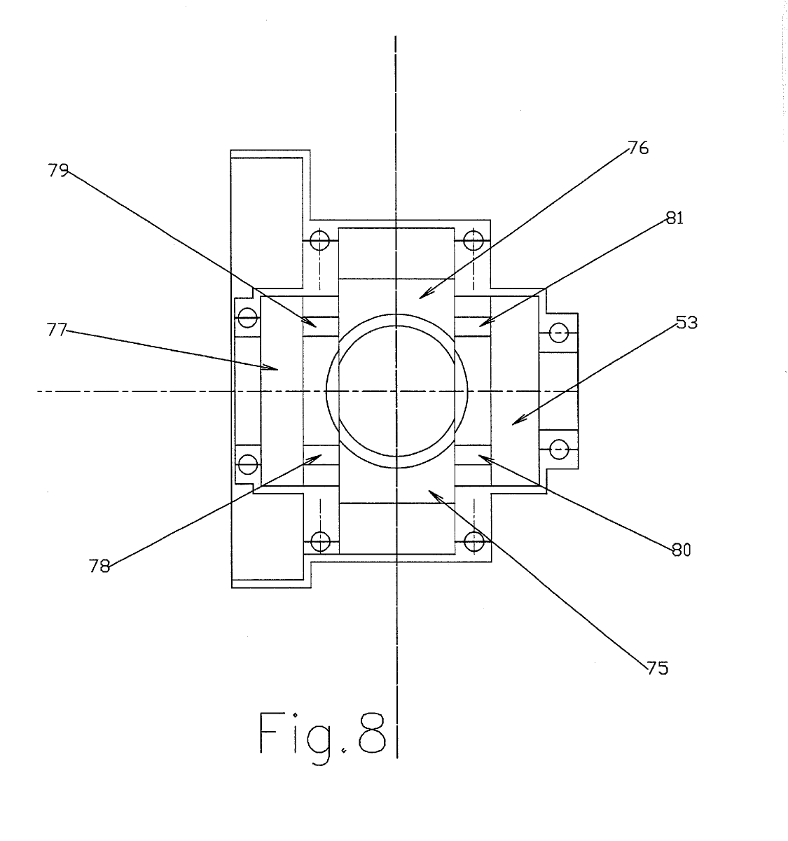

FIG. 7 is a section view of the cylinder block 1 and lower case 3 at the portion where the bearing 29 or 30 is supported. FIG. 8 is an elevation view of the cylinder block 1 seen from A illustrated in FIG. 7.

As illustrated in FIG. 1, another oil recess 77 is provided at the outside of the bearing 29. The oil recess 77 and the oil recesses 75, 76 of the crankshaft chamber 5 are communicated by slits 78 and 79 as illustrated in FIGS. 7 and 8.

By the same way, in the boss to support bearing 30, slits 80 and 81 are provided to communicate between the crankshaft chamber 5 and cam chamber 53.

By the reciprocating motion of the piston 6, pressure in the crankshaft chamber 5 changes up and down, and oil mist in the crankshaft chamber 5 is pushed out to the cam chamber 53 and lubricate the valve actuating parts in the cam chamber 53.

As illustrated in FIG. 1, at the bottom of the cam chamber 53, a pipe 54 is provided. One end of the pipe opens to the cam chamber 53 and the other end of the pipe 54 opens to the oil reservoir 18 with a small distance from the wall of the bottom cover 17.

The axes of the intake valve 12 and the exhaust valve 15 are inclined to each other. Therefore, a corner 82 of a deck 84 of the cylinder head 8 near the inlet valve spring 83 in the valve chamber 43 is lower than the top of the deck 84. So, in the normal operation position of the engine in which the cylinder head 8 is upright, lubricating oil in the valve chamber 43 flows easily to the corner 82 of the deck 84 after lubricating the parts in the valve chamber 43.

A passage 85 is provided between the corner 82 of the deck 84 and the oil reservoir 18. At one end of the passage 85, a pipe 86 is provided in the oil reservoir 18 with a small distance from the wall of the bottom cover 17. Since intake and exhaust valves 12, 15 are inclined to each other, cooling performance of the engine in accordance with embodiment of the present invention is more efficient than that of the related art because a cooling air passage 124 between valves is wide.

Other parts not specifically referenced in the foregoing relate to a common four-cycle engine. As illustrated in FIG. 1, a spark plug 66 is installed in a spark plug hole formed in the cylinder head 8. A coil 67 is an ignition coil. A re-coil starter 68 having a re-winding rope 69 is provided at a side of crankshaft 4. At the lower corner of the lower case 3, a cooling air entrance 70 is provided for inhaling cooling air for the engine. The cooling air is generated by rotation of blade 71 on the flywheel 21.

A fuel tank 72 is provided below the oil reservoir 18 and is adequately spaced apart from the fuel tank 72. As illustrated in FIG. 2, in the fuel tank 72, a fuel filter 73 and a fuel pipe 74 are provided to inhale fuel into the carburetor 100 therethrough.

In order to achieve high power output and relatively low exhaust emission, the four-cycle engine in accordance with an embodiment of the present invention is provided with a compact combustion chamber 9. When the engine is started by pulling the winding rope 69 illustrated in FIG. 1, lubricating oil is immediately inhaled to the pump 45 by rotation of the rotors 46, 47 via a flexible tube 49. Lubricating oil is splashed into the cylinder bore through the holes 51 and 52 and into the cam chamber 53 through the slits 80 and 81. By means of the weight 50 supported by and connected to the flexible tube 49, oil is inhaled at any position of the engine. The oil mist in the cam chamber 53, in which the valve actuating parts are installed, lubricates the valve train and then flows into the air cleaner box through the passages 61 and 63 as shown in FIG. 2. When the pressure in the cylinder bore is negative, a port 65 formed in the wall of cylinder bore opens and the mist returns from the air cleaner case 62 into the cylinder bore through passage 64.

The excess oil after lubricating parts in the valve chamber 43 returns into oil reservoir 18 through the passage 85 shown in FIG. 2.

As illustrated in FIGS. 1 and 2, the circular arc wall 55 surrounds the counterweight webs 24, 26 at a slight distance from the web. The crankshaft webs 24 and 26 splash the oil to mist lubricate the internal engine parts.

After lubricating the engine parts, as the webs 24, 26 rotate, the oil returns into the oil reservoir 18 through the drain hole 56.

The excess oil in the cam chamber 53 returns into the oil reservoir 18 through the pipe 54.

Portable or transportable power tools are operated in various orientations. For instance, a typical brush cutter, which installs an engine at an upper end of the boom and a cutter at the lower opposite end of the boom, is usually operated with 25-40 degrees inclination of the boom relative to the ground.

In the present invention, the circular arc wall 55 is funnel shaped with a 20-45 degree conical angle. Therefore, lubricating oil is not agitated excessively by rotation of web 24 and drops into the oil reservoir 18 when a brush cutter is operated in normal operation position.

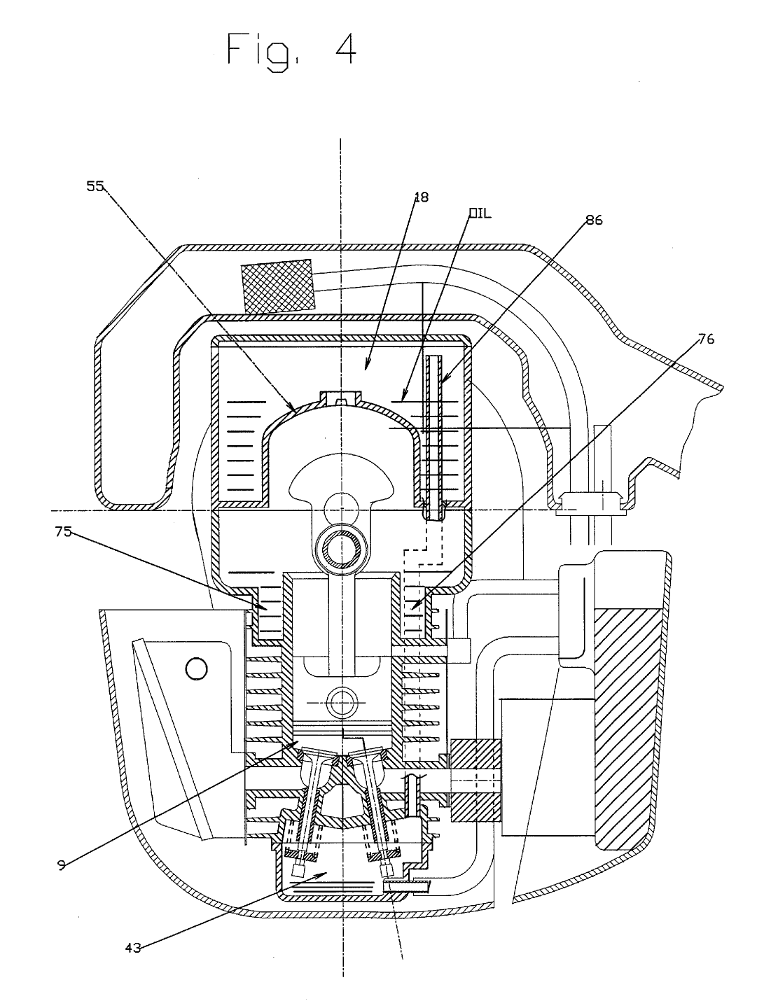

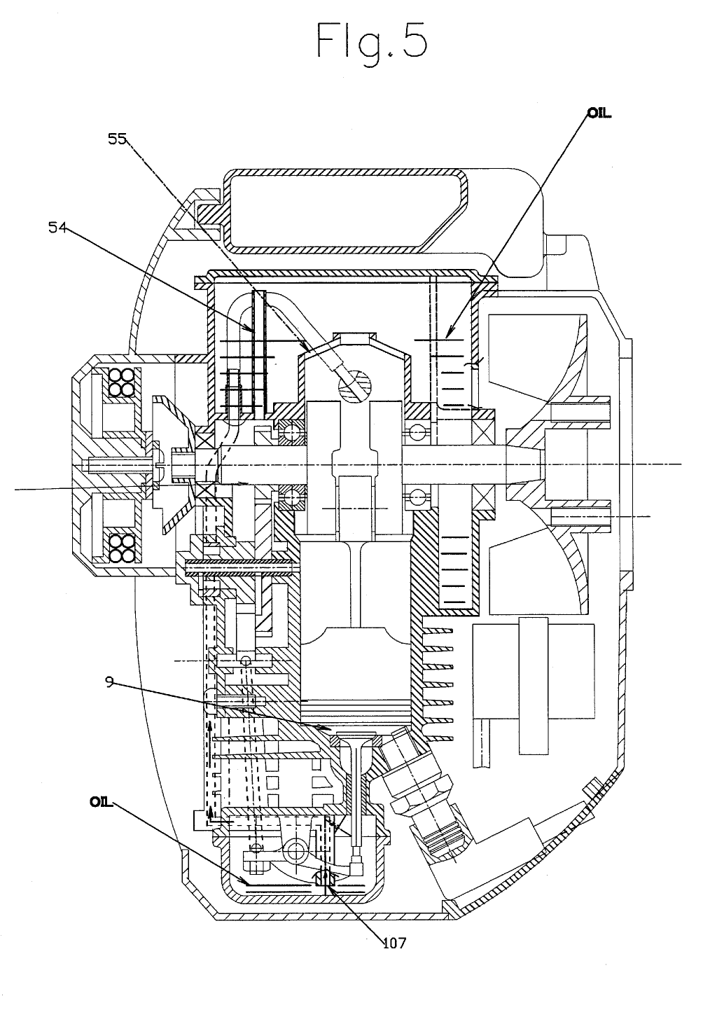

As illustrated in FIGS. 4 and 5, even when the engine is positioned upside down, lubrication oil in the oil reservoir 18 is maintained in the oil reservoir 18 owing to the circular arc wall 55, and oil is prevented from flowing into the cylinder head part. Further, oil in the crankshaft chamber 5 is maintained in the oil recesses 75, 76 (FIG. 4) and 77 (FIG. 5), and oil is prevented from flowing into the combustion chamber 9.

As illustrated in FIGS. 4 and 5, the pipe 54 (FIG. 5) prevents oil from flowing into the cam chamber 53 and the pipe 86 (FIG. 4) prevents oil from flowing into the valve chamber 43 when the engine is oriented upside down.

As illustrated in FIG. 1, when the engine is in a normal orientation, the lubricating oil is inhaled from the oil reservoir 18 through the small hole 109 into the valve chamber 43. Further, as illustrated in FIG. 5, when the engine is positioned upside down, the oil, after lubricating various parts in the valve chamber 43, is inhaled by pump 45 from the oil inlet 107 and sent to the pump 45 through the passage 104. Accordingly, excess oil does not remain in the valve chamber 43.

It is necessary to be sure that portable or transportable power tools are safely stored. For instance, even if a brush cutter is stored with a position with the vertical boom side up and the engine side down, lubrication oil should not flow into the combustion chamber 9. On the contrary, even if the same brush cutter is stored with a position with the vertical boom side down and the engine side up, lubrication oil also should not flow into the combustion chamber 9.

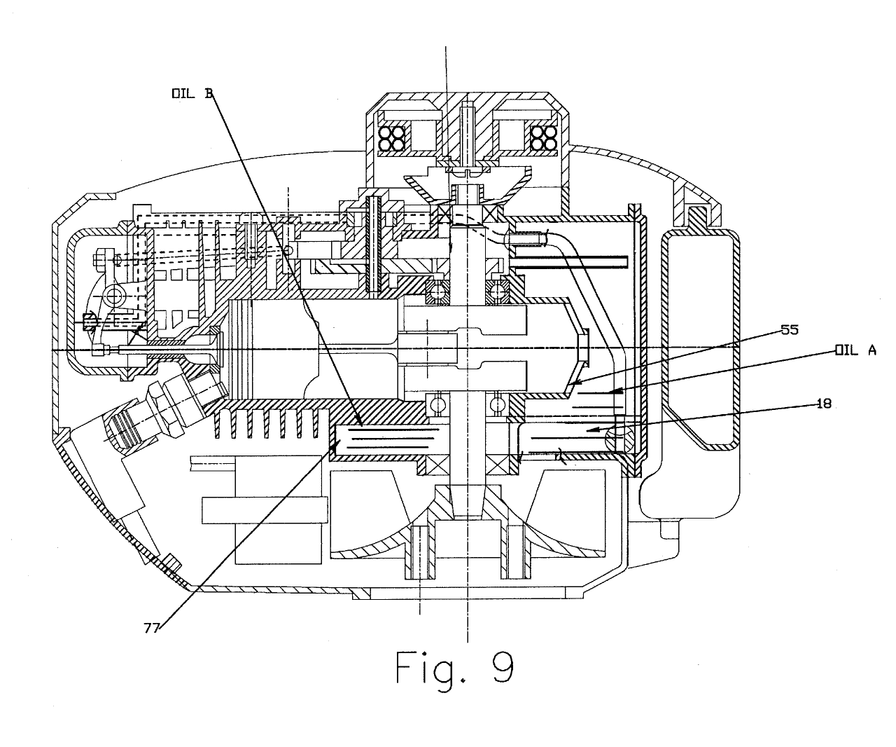

FIG. 9 illustrates storage of the engine when the output side of the engine is orientated downward. Oil A is maintained in the oil reservoir 18 and does not flow into the crankshaft chamber 5. Oil B is maintained in the recess 77 in the cylinder block 1 and does not flow into the crankshaft chamber 5.

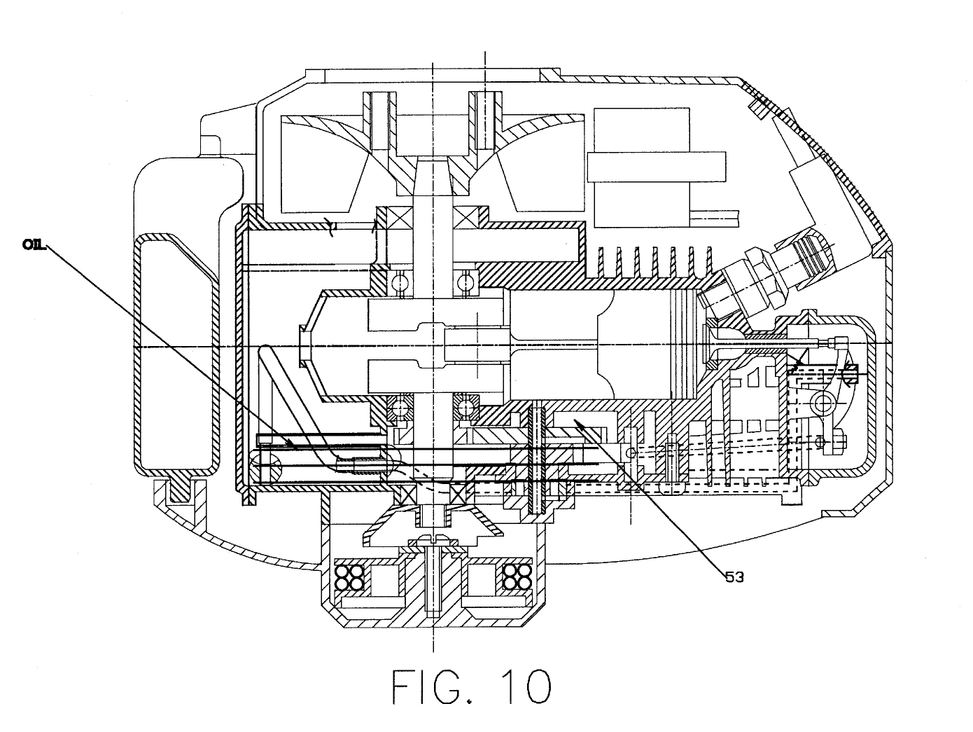

FIG. 10 illustrates storage of the engine when the output side of engine is oriented upward. Oil is maintained in the cam chamber 53 and does not flow into the crankshaft chamber 5.

The function of the relief passage 204 of the pump 45 is as follows: Assuming that the sectional area of oil passage of the hole to splash oil into the cylinder bore is S₁, the sectional area of relief passage is s₂, and the discharge volume by pump 45 is Q. Then, the discharge volume in to the cylinder bore is Q*S₁/(S₁+S₂). Return volume of oil to the oil reservoir 18 is Q*S₂/(S₁+S₂). So, by adequate design, in accordance with an embodiment of the present invention, a portion(s) of the oil discharged by the pump 45 always returns into the oil reservoir 18. On the other hand, in the related art, because no relief passage is provided in some operation condition, all of the oil in the oil reservoir 18 may be sucked and sent into the cylinder bore, and no oil returns into the oil reservoir 18. This may cause the crankshaft chamber 5 to be filled by a an excessive amount of oil. The embodiment of the present invention solves this problem.

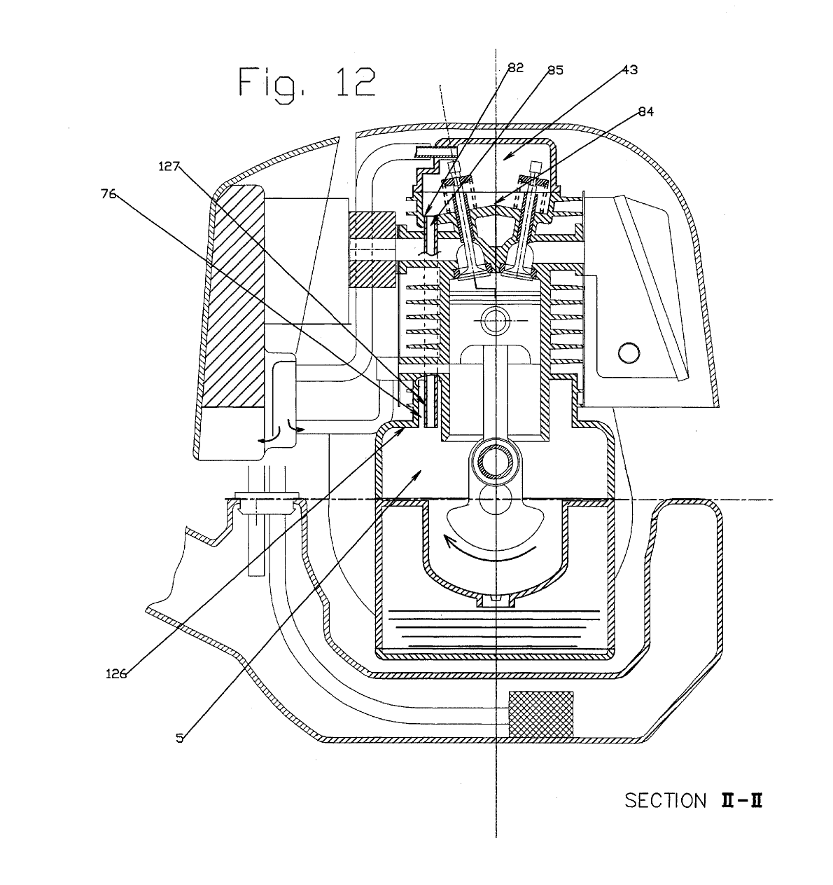

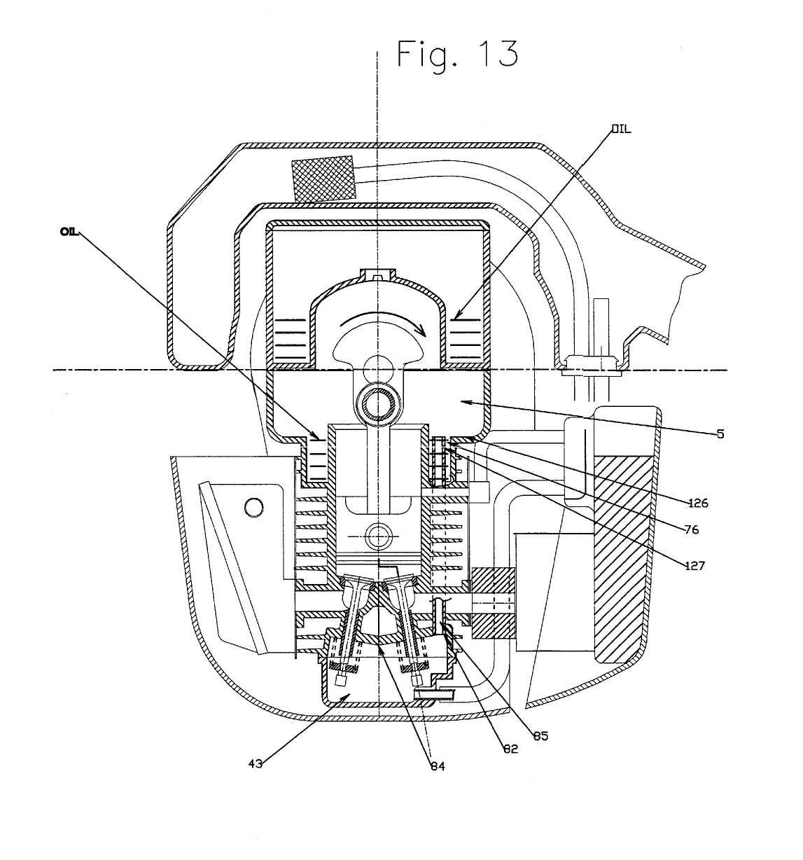

FIGS. 12 and 13 show one of other embodiments of the present invention, wherein a passage 85 is provided between the corner 82 of the deck 84 and the oil recess 76 in the cylinder block. At one end of the passage 85, a pipe is provided in the oil recess 76 with a similar height with the upper wall 127 of the crankshaft chamber 5. As illustrated in FIG. 13, the pipe 125 prevents oil from flowing into the valve chamber 43 when the engine is upside down.

The small light weight four cycle engines manufactured in accordance with the embodiment of the present invention is particularly suitable for, for example, the use with hand-held or transportable power tools having low emission. The engine is sufficiently light, so that the engine can be carried and/or transported. In the related art, effective lubricating methods for hand-held or transportable power tools have been presented. However, the methods of the related art require complicated arc and scroll shaped wall to control flow of lubricating oil in the engines and to prevent oil from flowing into cylinder head when engine is positioned upside down or vertical.

In the present invention, however, more simple and economic configurations are provided to solve the problem in the related arts.

Further, the configuration such as the pump in the related art may be applied to the embodiment of the present invention, so that specific feature and advantage of the related art are attained by the embodiment of the present invention.

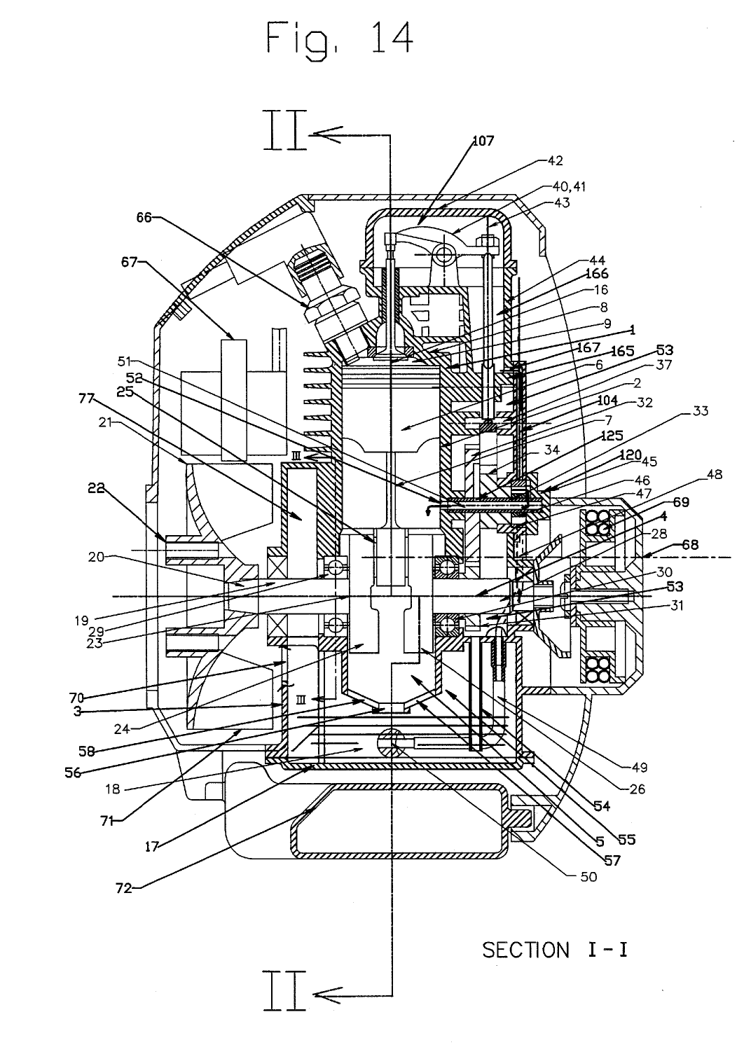

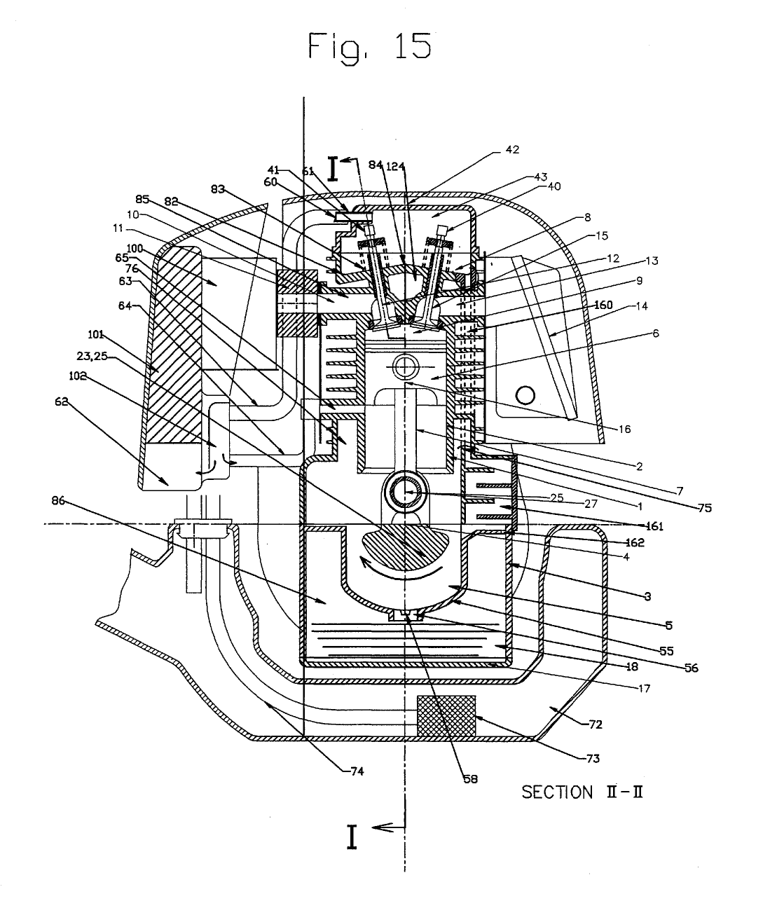

FIGS. 14, 15 illustrate another one of other embodiments of the present invention.

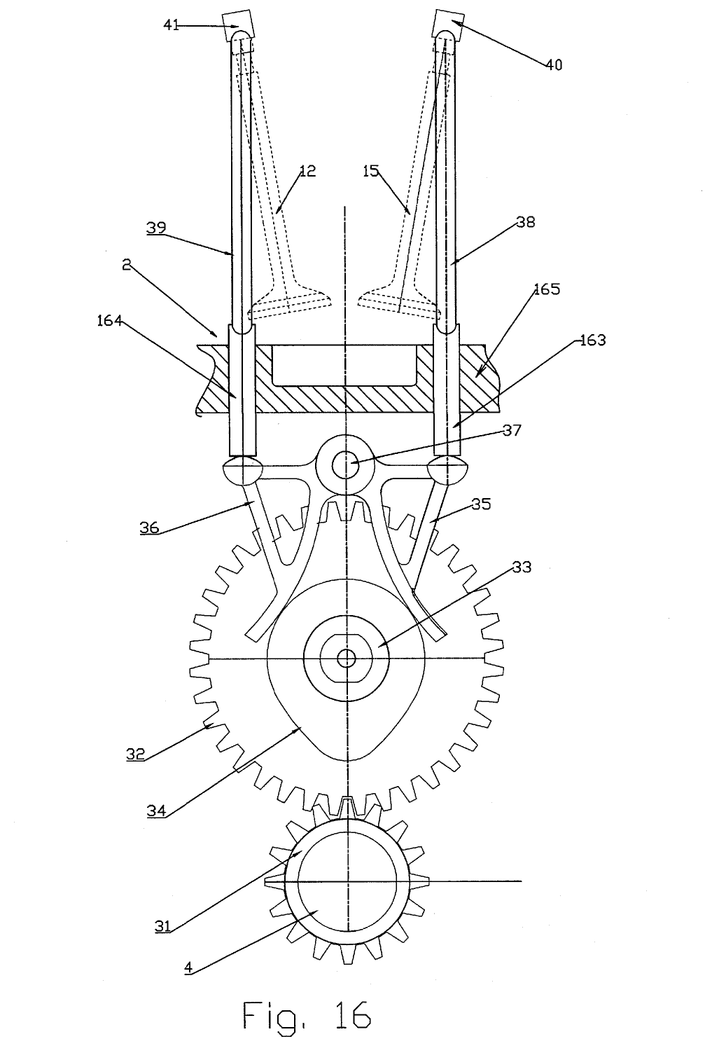

A cam shaft drive and valve lifter mechanism is best illustrated in FIG. 16. A crank gear 31 mounted on the crankshaft 4 in turn drives a cam gear 32 with twice the number of teeth as the crank gear 31, resulting in the cam shaft 33 rotating in one-half engine speed. The cam gear 32 is affixed to a cam shaft 33 which is journaled to the cylinder block 1 and includes a rotary cam lobe 34. In the embodiment illustrated, a single cam lobe is utilized for driving both the intake and exhaust valves. Cam shaft followers 35 and 36 are pivotally connected to the cylinder block 1 by a pivot pin 37.

Intermediated lifters 163 and 164 are slidably installed in a partition deck 165 of the cylinder block 2.

Push rods 37/38 extend between one ends of the intermediate lifters 163/164 and rocker arms 40/41 located within the cylinder head 8. The other ends of the intermediate lifters 163/164 contact with the cam shaft followers 35/36.

The cam 34, intermediate lifters 163/164, push rods 38/39, and rocker arms 40/41 are part of a valve train assembly, wherein the axes of push rods 38/39 are substantially parallel to a plane which includes the cylinder axis 16 and the crankshaft axis 4. A valve cover 42 is affixed to the cylinder head 8. The valve cover 42 defines an enclosed valve chamber 43 between the valve cover 42 and the cylinder head 8.

A wall 44 surrounds the push rods 38/39 in a conventional manner in order to prevent the entry of dirt into the engine. The wall 44 and the partition deck 165 of the cylinder block 2 define a push rod chamber 166, wherein the push rod chamber communicates to the valve chamber 43.

By the partition deck 165, in which the intermediate lifters 163/164 slide, the push rod chamber 166 is partitioned fluid-ably from the cam chamber 53.

The pump mechanism of the embodiment shown in FIGS. 14 and 15 is the same as that illustrated in FIG. 11. The engine parts inside the crankshaft chamber 5 and the cam chamber 53 are mist lubricated by the oil splashed by means of the rotation of and/or the centrifugal force generated by the rotating parts such as web 24, 26.

At the bottom side of the push rod chamber 166, a drilled oil passage 104 is provided. One end of the passage 104 leads to the oil entrance of the pump together with the passage 48. The other end of passage 104 leads to a bottom hole 167 in the push rod chamber 166 as illustrated in FIG. 14.

Between the crankshaft chamber 5 and valve chamber 43, a breather passage 160 is provided. One end of the breather passage opens to the valve chamber 5. The other end of the breather passage communicates to an oil separating chamber 161 which is provided at the wall surrounding the crankshaft chamber 5. One end of the oil separating chamber opens to the crankshaft chamber 5. At the bottom of the oil separating chamber 161, a drain hole 162 is provided between the oil separating chamber 161 and the crankshaft chamber 5.

A breathing gas including lubrication oil enters into the oil separating chamber 161 when pressure in the crankcase is positive by a down stroke of the piston 6. Excess oil is separated and drained to the oil reservoir 18 via a hole 162. Then, the breathing gas is sent into the valve chamber 43 through the breather passage 160. Lubrication oil included in the breather gas lubricates moving parts in the valve chamber 43 and the push rod chamber 166.

Then, the breathing gas is sent to the air cleaner 101 as described in the first embodiment illustrated in FIGS. 1 and 2.

Excess oil after lubricating moving parts in the valve chamber 43 and the push rod chamber 166 is inhaled into the pump 45 through holes 167 and passage 104.

Advantages of the above-described embodiment of present invention are as follows. First, lubrication to the valve chamber is adequately controlled in any position of operation. That is, even if the engine, that is oriented in a normal position, suddenly becomes upside down, lubrication oil in the cam chamber does not flow into the valve chamber 43, because the valve chamber 43 and the cam chamber 53 are fluid-ably separated by the partition deck 165 (i.e. separated by way of fluid).

Second, cooling efficiency of the engine is higher than the related arts. That is, since the inlet and exhaust valves incline each other, the cooling air passage 124 between the inlet and exhaust valves of the embodiment of the present invention is wider than the related arts, as illustrated in FIGS. 2 and 15.

Third, the length of the push rod in this embodiment is significantly shorter than that of the related arts (e.g., U.S. Pat. Nos. 7,287,508, 7,624,714), so that the spring constant of the push rods is larger, and natural frequency of a valve train is higher than that of the related arts. Natural frequency of the valve train is an important factor to be considered in design of a high speed, light weight over-head valve engine.

Further, the present invention is not limited to these embodiments, but various variations and modifications may be made without departing from the scope of the present invention.

What is claimed is:

1. A valve train for a four-cycle internal combustion engine comprising:
a cam shaft mounted in a cam chamber having a single cam lobe, the cam lobe is driven by a crankshaft and rotates at one-half crankshaft speed; and
a pair of cam followers, each pivotally mounted and rotatable about an axis that is parallel to the cam shaft; the pair of cam followers rock in response to the rotation of the cam lobe, at least one rocker arm and at least one valve train push rod extending therefrom and engaging said rocker arm, the opposite end of said push rod being drivably connected to an end of an intermediate lifter, another end of the intermediate lifter is connected to the arm of the cam follower.

2. The engine set forth in claim 1, wherein the crankshaft, the cam shaft, the axis of said cam follower and a cylinder bore axis substantially lie in a common central plane.

3. The engine set forth in claim 1, wherein axes of said push rods and axes of said intermediate lifters are substantially parallel to a plane which includes said crankshaft axis and a cylinder bore axis.

4. The engine set forth in claim 1, wherein the inlet valve and the exhaust valve are inclined to the a cylinder axis, respectively.

5. The engine set forth in claim 1,
wherein the intermediate lifter is configured to reciprocate upon rotation of the cam lobe,
wherein the cam follower is configured to rock upon the rotation of the cam lobe,
wherein the reciprocation of the intermediate lifter and the rocking of the cam follower actuate the push rod.

6. A four-cycle internal combustion engine comprising:
a cylinder block having a cylinder, a cylinder head, a piston mounted for reciprocation in said cylinder, said cylinder head defining an air-fuel combustion chamber;
a valve cover on said cylinder head defining a valve chamber;
an intake valve and an exhaust valve;
a valve train in the valve chamber, said valve train including at least one rocker arm and at least one valve train push rod extending therefrom within said valve chamber and engaging said rocker arm; at least one push rod chamber defined by wall surrounding said push rod and communicated to said valve chamber;
a crankshaft chamber;
a crankshaft rotatably in said crankshaft chamber;
a crank gear mounting on the crankshaft for rotation therewith;
a cam chamber;
a cam shaft mounted in said cam chamber having a cam gear cooperating with the crank gear and a single cam lobe; said cam gear and said cam lobe are driven by the crankshaft at one-half crankshaft speed;
a pair of cam followers pivotally mounted on an axis, which is parallel to the crankshaft axis of rotation, respectively; said cam follower engaging the cam lobe and being rocked in response to the rotation of the cam lobe, the opposite end of said push rod being drivably connected to an end of an intermediate lifter; another end of the intermediate lifter is connected to the arm of the cam follower.

7. The engine set forth in claim 6, wherein the intermediate lifter is configured to reciprocate upon rotation of the cam lobe,
wherein the cam follower is configured to rock upon the rotation of the cam lobe,
wherein the reciprocation of the intermediate lifter and the rocking of the cam follower actuate the push rod.

8. A four-cycle internal combustion engine comprising:
a cylinder block having a cylinder, a cylinder head, a piston mounted for reciprocation in said cylinder, said cylinder head defining an air-fuel combustion chamber;
a valve cover on said cylinder head defining a valve chamber;
an intake valve and an exhaust valve;
a first valve train in a valve chamber, said first valve train including at least one rocker arm and at least one push rod extending therefrom within said valve chamber and engaging said rocker arm;
at least one push rod chamber defined by wall surrounding said push rod and communicated to said valve chamber;
a crankshaft chamber;
a crankshaft rotatably in said crankshaft chamber;
a crank gear mounting on the crankshaft for rotation therewith;
a cam chamber;
a cam shaft mounted in said cam chamber having a cam gear cooperating with the crank gear and a single cam lobe;
a second valve train actuated by a single cam lobe;
a partition deck provided between said push rod chamber and said cam chamber, wherein said partition deck separates said valve chamber from said cam chamber by way of a fluid;
a lubrication oil reservoir formed below the crank shaft chamber;
oil supply units which inhale lubrication oil from said oil reservoir and splashes the oil to at least one of the cylinder, the crankshaft chamber, the cam chamber, the valve chamber, and the push rod chamber; and
oil drain units to drain excess lubrication oil from at least one of the valve chamber, the push rod chamber, and the cam chamber to the crankshaft chamber or the oil reservoir.

9. The engine set forth in claim 8, wherein one of said oil supply units is an oil pump driven by at least one of the cam gear, the cam lobe, and the cam shaft.

10. The engine set forth in claim 8, wherein one of said oil supply units is configured to carry an oil mist from the crankshaft chamber to the valve chamber through a breathing passage.

11. The engine set forth in claim 8,
wherein one of said oil drain units is a pump that is driven by at least one of the cam gear, the cam lobe, and the cam shaft,
wherein one of said oil drains units is configured to inhale excess lubrication oil from the valve chamber or the push rod chamber.

12. The engine set forth in claim 8, wherein one of said oil drain units is at least one passage communicating between the cam chamber and the oil reservoir.

13. The engine set forth in claim 8, wherein one of said oil drain units is a breather passage communicating between the valve chamber and the air cleaner.
